(19) United States
(12) Patent Application Publication
(10) Pub. No.: US 2026/0104680 A1
(43) Pub. Date: Apr. 16, 2026

(54) INTELLIGENT PRODUCTION METHOD AND RELATED DEVICE BASED ON DIRECTED ACYCLIC GRAPH

(71) Applicants: Beijing Jiaotong University, Beijing (CN); Ganzhou Innovation Institute of Intelligent Industry, Ganzhou (CN)

(72) Inventors: Minghao ZHU, Beijing (CN); Qifeng WANG, Beijing (CN); Bo GAO, Beijing (CN); Weiwei DU, Beijing (CN); Tao JING, Beijing (CN); Xuehan LI, Beijing (CN); Hao WU, Beijing (CN); Yan HUO, Beijing (CN); Qinghe GAO, Beijing (CN); Boyang ZHANG, Beijing (CN); Yihang WANG, Beijing (CN); Zha LIU, Beijing (CN); Xiaoxuan WANG, Beijing (CN)

(73) Assignees: Beijing Jiaotong University, Beijing (CN); Ganzhou Innovation Institute of Intelligent Industry, Ganzhou (CN)

(21) Appl. No.: 19/308,780

(22) Filed: Aug. 25, 2025

(30) Foreign Application Priority Data
Oct. 16, 2024 (CN) 202411445318.0

(51) Int. Cl. G05B 13/02; G06N 7/01; G06Q 50/04

(52) U.S. Cl. CPC G05B 13/028; G06N 7/01; G06Q 50/04

(57) ABSTRACT

In an intelligent production method, external dependency relationships between different ME and internal dependency relationships within a same ME are determined. A composite DAG, a device model, a smart factory model are constructed. Then, the smart factory model is solved using a linear goal programming algorithm with an objective of minimizing a total cost, to obtain an optimal transmission power allocation ratio and an optimal offloading decision. An optimal production plan is determined based on the optimal transmission power allocation ratio and the optimal offloading decision. And an intelligent production is executed according to the optimal production plan.

### CROSS-REFERENCE TO RELATED APPLICATIONS

This application claims priority to Chinese Patent Application No. 202411445318.0, filed on Oct. 16, 2024, the content of which is incorporated herein by reference in its entirety.

### TECHNICAL FIELD

This disclosure relates to the field of communication technologies, and particularly to an intelligent production method and related devices based on a Directed Acyclic Graph (DAG).

### BACKGROUND

With the rise of intelligent manufacturing, industrial internet has experienced rapid developments, where visions of digitalization, intelligence, and networking are gradually becoming reality. In practical smart factory scenarios, researches on task dependency relationships between manufacturing equipment (ME) primarily focuses on data-sharing ratios. However, in practice, data sharing requires a support from the transmission power. Furthermore, regarding the production cost optimization, existing technical solutions often fail to consider the intrinsic energy constraints of MEs and time limitations for individual production tasks, which may lead to an energy depletion and a production stagnation.

### SUMMARY

In view of the above, examples of the present disclosure provide an intelligent production method, devices, and storage medium based on a DAG, which may minimize production costs while completing tasks within specified timeframes under a guaranteed energy sufficiency.

The intelligent production method based on a DAG according to examples of the present disclosure may include: determining external dependency relationships between different MEs and internal dependency relationships within a same ME; constructing a composite DAG based on the external dependency relationships and the internal dependency relationships; wherein, each ME needs to execute at least one task; constructing the composite DAG based on the external dependency relationships and the internal dependency relationships comprises: determining an internal task set and an internal dependency set according to the internal dependency relationships; defining a start task and an exit task in the internal task set as virtual tasks; defining intermediate tasks in the internal task set as real tasks; determining an external dependency set according to the external dependency relationships; and constructing the composite DAG based on the internal dependency set, the external dependency set and the internal task set; constructing a device model based on performance parameters of each ME and each edge server; constructing a smart factory model based on the composite DAG, the device model, and task information of each ME; solving the smart factory model using a linear goal programming algorithm with an objective of minimizing a total cost, to obtain an optimal transmission power allocation ratio and an optimal offloading decision; determining an optimal production plan based on the optimal transmission power allocation ratio and the optimal offloading decision; and executing an intelligent production according to the optimal production plan.

Based on the same inventive concept, examples of the present disclosure further provide an electronic device, comprising a memory, a processor, and a computer program stored on the memory and executable by the processor, wherein the processor implements the method as described above when executing the computer program.

Based on the same inventive concept, this application further provides a non-transitory computer-readable storage medium storing computer instructions, wherein the computer instructions are used to cause a computer to execute the method as described above.

As can be seen from the foregoing description, the intelligent production method and related devices based on a DAG provided may determine dependency relationships, construct a composite DAG, build a device model and a smart factory model, solve for optimal transmission power allocation and offloading decisions, and execute intelligent production. By constructing the composite DAG, unified managements of task dependencies may be achieved, providing a foundation for a rational allocation of transmission power resources between edge servers and other MEs. The device model may quantify intrinsic performance constraints of the MEs. The smart factory model may simulate actual production processes, and its optimization may minimize a total energy and time costs. Crucially, the model inherently restricts parameters such as transmission power allocation ratios, device energy consumptions, and task runtimes. It can be seen that, in examples of the present disclosure, sufficient energies may be available to prevent production interruptions; predefined task deadlines may be satisfied; and a feasibility of an optimal production plan may be guaranteed.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 is a flowchart of the intelligent production method based on a DAG according to an example of the present disclosure.

FIG. 2 is a schematic diagram of the smart factory model according to an example of the present disclosure.

FIG. 3 is a schematic diagram of the composite DAG according to an example of the present disclosure.

FIG. 4 is a flowchart for constructing the smart factory model according to an example of the present disclosure.

FIG. 5 is a flowchart for solving the smart factory model via linear goal programming to minimize costs according to an example of the present disclosure.

FIG. 6 is a structural diagram of the intelligent production apparatus based on a DAG according to an example of the present disclosure.

FIG. 7 is a structural diagram of an electronic device according to an example of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by persons skilled in the art. The terms “first,” “second,” and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper,” “lower,” “left,” and “right” are used only to indicate relative positional relationships. When the absolute position of the described object changes, the relative positional relationship may also change accordingly.

In this document, it should be understood that the number of elements in the drawings is for illustration rather than limitation, and any naming is for differentiation only, without restrictive implications.

Based on the description of the background technology above, the following situations also exist in related technologies.

Intelligent Manufacturing (IM) refers to a human-machine integrated intelligent system composed of intelligent machines and humans. It aims to achieve supervised intelligent activities in the manufacturing process through analysis, reasoning, judgment, and decision-making. By enabling humans and machines to collaborate, it extends, augments, and partially replaces the physical and mental activities of human experts in manufacturing. This expands the concept of manufacturing automation towards flexibility, integration, and holistic intelligence.

Industrial Internet of Things (IIoT) refers to a new type of infrastructure, application model, and industrial ecosystem formed by the deep integration of next-generation information and communication technologies with the industrial economy. By comprehensively connecting people, machines, objects, and systems, it constructs a new manufacturing and service system covering entire industrial chains and value chains. It provides an implementation pathway for the digitalization, networking, and intelligent development of industry and broader sectors.

Mobile Edge Computing (MEC) refers to an edge computing paradigm that uses network edge nodes to process and analyze data. As the heterogeneity and complexity of communication network architectures increase, the inherent limitations of traditional cloud computing—such as limited computational resources and high processing latency—become apparent. The introduction of MEC can effectively offload computational pressure from the central processor (CPU), thereby significantly improving network architecture performance.

Task offloading is a key technology in edge computing. Computational offloading in edge computing involves transferring computational tasks from mobile devices to an edge cloud environment. This addresses device limitations in areas such as resource storage, computational performance, and energy efficiency.

A DAG is a graph theory data structure composed of vertices and directed edges. Each edge has a direction, and no cycles exist within the graph. DAGs are commonly used to describe dependency relationships between a series of tasks or events, such as task flows in engineering projects or code dependencies in compilers. Due to the absence of cycles, DAGs possess strong computability and reliability, enabling efficient operations like topological sorting.

In related technologies for task scheduling of MEs in smart manufacturing factories within industrial internet scenarios, existing technical solutions either consider a single DAG or only a single edge server. However, in real-world smart factories, various MEs are present, each with naturally distinct production tasks. For the sake of simplicity, a production task will be referred to as a task in the following text. Consequently, different DAGs are needed to represent them. Furthermore, as the number of MEs increases, so do the tasks. Relying on a single edge server is insufficient to support the execution of all tasks, potentially leading to task queuing and congestion, thereby increasing time costs.

Specifically, in a real-world smart factory scenario, the external dependencies between MEs may impact the allocation of transmission power. Within a smart manufacturing factory, on one hand, the tasks of some devices require data generated by the execution results of tasks from other MEs. For instance, certain tasks may need temperature, humidity, or other data provided by sensor devices. This means data sharing exists between the tasks of different MEs, and the prerequisite for this data sharing is the allocation of corresponding transmission power. On the other hand, during task execution, tasks might be offloaded to edge servers. The data transmission required for this offloading process also necessitates corresponding transmission power.

Further, in the smart factory scenario, constraints regarding the limited energy of MEs themselves and the finite runtime of tasks are often neglected. Cost minimization problems in smart manufacturing factories frequently fail to consider the energy limitations inherent to the MEs. However, in actual smart factories, each ME has a finite amount of energy. These devices tend to prioritize completing their own tasks first, using any remaining energy for data sharing with other tasks. Simultaneously, if the runtime of each task is left unconstrained, the excessive runtime of certain tasks can lead to production delays, thereby increasing time costs.

The intelligent production method and related devices based on a DAG provided by examples of the present disclosure may determine the external dependency relationships between different MEs and the internal dependency relationships within the same ME. A composite DAG may then be constructed according to the external and internal dependency relationships. A device model may be established based on performance parameters of each ME and performance parameters of each edge server. An intelligent factory model may be built using the composite DAG, the device model, and the task information of each ME. With the goal of minimizing the cost, the intelligent factory model may be solved using a linear goal programming algorithm to obtain the optimal transmission power allocation ratio and the optimal offloading decision. The optimal production plan may be determined based on the optimal transmission power allocation ratio and the optimal offloading decision, and intelligent production may be carried out according to this plan. By constructing the composite DAG based on internal and external dependency relationships, unified management of the dependencies between tasks may be achieved. This provides the dependency foundation for rationally allocating transmission power resources between sending data to edge servers and sending data to other MEs. The device model may determine the constraints imposed by the MEs' own performance. The intelligent factory model may simulate the actual production process. Solving this model with the goal of minimizing cost may yield the optimal transmission power allocation ratio and offloading decision. These optimal solutions may minimize both the energy cost and time cost of the intelligent factory. Furthermore, the intelligent factory model inherently constrains parameters such as the transmission power allocation ratio, the energy consumption of the MEs themselves, and production time. This guarantees that the optimal production plan will not exceed the time constraints of the tasks nor lead to production stalls due to insufficient energy. Consequently, while minimizing production costs, it ensures each ME has sufficient energy support and meets all time constraints.

Examples of the present application provide an intelligent production method based on a DAG, which will be described in detail below in conjunction with the accompanying drawings.

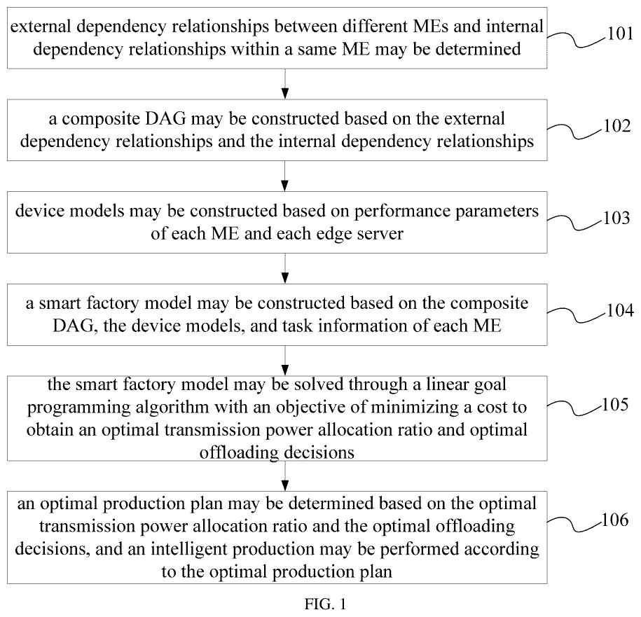

In some examples of the present disclosure, as shown in FIG. 1, an intelligent production method based on a DAG may include the following steps.

In block 101, external dependency relationships between different MEs and internal dependency relationships within a same ME may be determined.

In some examples of the present disclosure, for a smart factory including N MEs, the i^{th} ME of the smart factory can be denoted as MEᵢ, i∈{1, 2, . . . , N}.

The execution task of each ME may include tasks with dependency relationships, which means that the execution task may include at least one task. The internal dependency relationships within the same ME may refer to a sequential execution order between different tasks of that ME. The ME may execute tasks sequentially according to the internal dependency relationships during the operation. For instance, the ME may execute a first task, followed by a second, then a third task, and so on, until a final task is executed. At this time, the ME may either conclude operation or proceed to a next cycle of tasks.

The external dependency relationships between different MEs may refer to a sequential execution dependencies that exist between tasks across different MEs. Specifically, during manufacturing in a smart factory, different MEs often need to cooperate to complete the manufacturing of corresponding products, resulting in inherent external dependencies between them. For example, upon a completion of the second task of MEᵢ, the third task of MEᵢ might need to be executed. However, at the same time, a fifth task of MEⱼ, another ME needs to be executed.

In block 102, a composite DAG may be constructed based on the external dependency relationships and the internal dependency relationships.

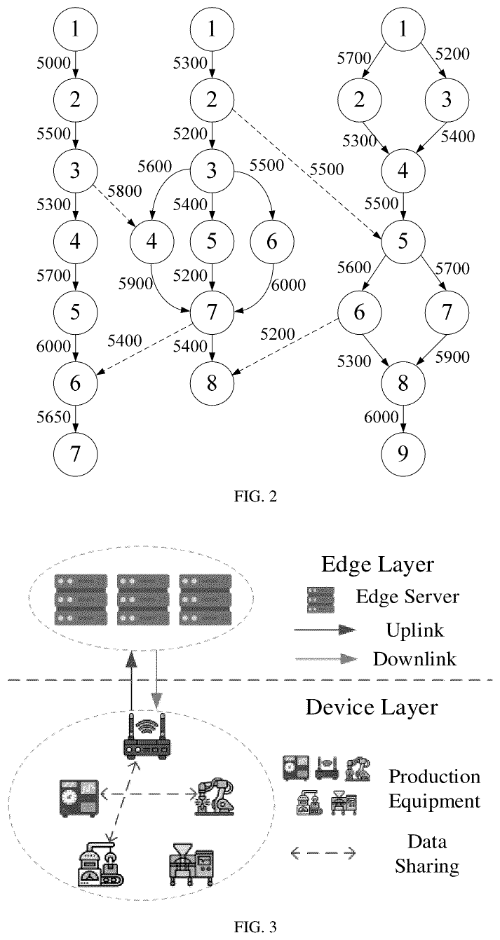

In a some examples of the present disclosure, for a first DAG, 1→2→3→4→5→6→7, the sequence can be determined directly according to the internal dependency relationships of the first DAG. For example, after executing the third task of the first DAG, the system may proceed to the fourth task based on the internal dependency relationships. However, according to the external dependency relationships, while continuing to execute its own fourth task, the system must also execute the fourth task on another interconnected ME. Therefore, multiple individual DAGs may be constructed based on the internal dependency relationships. These individual DAGs are then combined according to the external dependency relationships, resulting in a composite DAG shown in FIG. 2. This composite DAG may represent an execution sequence of all tasks across N MEs.

In some examples of the present disclosure, each ME needs to execute at least one task. Constructing the composite DAG based on the external dependency relationships and the internal dependency relationships may include the following steps.

In a first step, an internal task set and an internal dependency set of each ME may be determined according to the internal dependency relationships.

Then, a start task and an exit task in the internal task set may be defined as virtual tasks. Further, intermediate tasks in the internal task set may be defined as real tasks.

In some examples, assuming that the internal task set corresponding to MEᵢ may be denoted as Qᵢ={q_{i,0}, q_{i,1}, q_{i,2}, . . . , q_{i,D}_{ᵢ}, q_{i,D}_{ᵢ}₊₁}. The first executed task q_{i,0} in the set may be designated as the start task. The last executed task q_{i,D}_{ᵢ}₊₁ in the set may be designated as the exit task. Since both the start task and the exit task are handled locally by MEᵢ and require zero computational resources during executions, they may be defined as virtual tasks. Consequently, all tasks in the internal task set except these virtual tasks are defined as real tasks. Here, Dᵢ represents the number of tasks to be executed by MEᵢ. Dᵢ also represents the number of real tasks in the internal task set. For any task q_{i,j}, subscript i denotes the i^{th} ME and subscript j denotes the j^{th} task. Let IDᵢ represent the internal dependency set of MEᵢ. Then, an element in the internal dependency set {id(q_{i,j},q_{i,k})|j∈{0,1,2, . . . , Dᵢ}, q_{i,k} ∈suc(q_{i,j})} may denote a directed edge from task q_{i,j} to task q_{i,k}. A data transmission volume can be denoted as

$${id}_{i , j}^{i , k} .$$

This signifies that after executing task q_{i,j}, task q_{i,k} should be executed next, with a data transmission volume of

$${id}_{i , j}^{i , k}$$

between them.

In a second step, an external dependency set of each ME may be determined based on the external dependency relationships. Let EDᵢ represent the external dependency set of MEᵢ. Then, an element in the external dependency set {ed(q_{i,j}, q_{i′,j′})|i≠i′, j∈{0,1,2, . . . , Dᵢ}, j′∈{0,1,2, . . . , D_{i′}}} may denote a directed edge from q_{i,j} to task q_{i′,j′}. A data transmission volume can be denoted as

$${ed}_{i , j}^{{i}^{′} , {j}^{′}} .$$

This signifies that after executing task q_{i,j}, task q_{i′,j′} of another ME should be executed next, with a data transmission volume of

$${ed}_{i , j}^{{i}^{′} , {j}^{′}}$$

between them. An individual DAG for MEᵢ can thus be defined as Gᵢ=(Qᵢ,IDᵢ,EDᵢ).

In a third step, a composite DAG may be constructed based on the internal dependency sets, the external dependency sets, and the internal task sets.

It can be seen that, the tasks of a single ME can be determined based on its internal task set. Therefore, all tasks that the smart factory needs to execute can be determined by the internal task sets of all MEs. The internal dependency set may contain dependency relationships among all tasks within the internal task set corresponding to the same ME. The external dependency set may contain dependency relationships between tasks of different MEs. Therefore, a comprehensive understanding of all tasks and their interdependencies may be obtained by integrating the internal dependency sets, the external dependency sets, and internal task sets of all MEs. Therefore, multiple individual DAGs may be constructed based on the internal dependency relationships first. Within these DAGs, tasks may be defined as virtual tasks or real tasks based on the internal task sets. Then, these individual DAGs may be combined according to the external dependency relationships, resulting in the composite DAG shown in FIG. 2. In this DAG, the numbers between different tasks represent the data transmission volumes. Using this composite DAG to describe the dependency relationships among all tasks in the smart factory may offer a strong computability and a strong reliability due to its acyclic nature. This enables efficient operations such as topological sorting, providing a solid foundation of dependency relationships for subsequent model construction.

By constructing the composite DAG based on the internal dependency relationships and the external dependency relationships, a unified management of the dependency relationships between tasks can be achieved. This provides an essential dependency relationship foundation for rational allocations of transmission power resources between sending data to edge servers and sending data to other MEs.

In block 103, device models may be constructed based on performance parameters of each ME and each edge server.

It can be seen that, the composite DAG provides knowledge of all tasks within the smart factory and their interdependencies. The MEs and edge servers, acting as the executors of these tasks, are subject to their own constraints. Under normal operating conditions without device or server replacement, the performance parameters of the MEs and the edge servers remain fixed. Therefore, it is necessary to construct device models based on the performance parameters of each ME and each edge server first. This process may determine the capabilities of the MEs and the edge servers, establishing foundational model data for the subsequent construction of the smart factory model.

By way of example, consider a smart factory with N MEs and M edge servers (ES) randomly distributed. A ME may be denoted as MEᵢ, i∈{1,2, . . . , N}. The computational capability of MEᵢ may be denoted as fᵢ, the operating power may be denoted as

$${p}_{i}^{ME} ,$$

the transmission power may be denoted as

$${p}_{i}^{trans} ,$$

the reception power may be denoted as

$${p}_{i}^{r e c e i} ,$$

the standby power may be denoted as

$${p}_{i}^{wait} ,$$

and the available energy may be denoted as

$${E}_{i}^{ME} .$$

An edge server can be denoted as ESₘ, m∈{1,2, . . . , M}. The computational capability of edge server ESₘ may be denoted as fₘ. Each edge server can execute multiple tasks concurrently, and the production operations on each ME may start simultaneously. Therefore, the device models may be constructed to determine limitations of the ME's own performance. For instance, the maximum energy usable by MEᵢ cannot exceed the energy constraint of its available energy

$${E}_{i}^{ME} ;$$

the maximum transmission power when sending task data cannot exceed the transmission power constraint

$${p}_{i}^{trans} ;$$

the reception power when receiving task data cannot exceed the reception power constraint

$${p}_{i}^{r e c e i} ;$$

and the operating power during idle operation cannot exceed the standby power constraint

$${p}_{i}^{wait} .$$

In block 104, a smart factory model may be constructed based on the composite DAG, the device models, and task information of each ME.

In some examples of the present disclosure, the smart factory may be abstracted into the smart factory model shown in FIG. 3 by comprehensively considering the devices' own energy, the execution time of the tasks, and the computational capabilities of the edge servers. The smart factory model may feature a two-layer wireless communication network structure, which includes an upper edge layer and a lower device layer. The smart factory model may include the device models, a task model, communication models, task execution models, and an external dependency evaluation model. Therefore, the process of building the smart factory model can be broken down into constructing these individual models (the device models, the task model, the communication models, the task execution models, and the external dependency evaluation model), and integrating these individual models constructed into the complete smart factory model.

In block 105, the smart factory model may be solved through a linear goal programming algorithm with an objective of minimizing a cost to obtain an optimal transmission power allocation ratio and optimal offloading decisions.

In some examples of the present disclosure, a cost objective function may be formulated with a goal of minimizing a cost at first. Then, using the linear goal programming algorithm on the basis of the smart factory model, a solution may be derived. The smart factory model may simulate an actual smart factory and thus defines constraints for solving the cost objective function. Consequently, solving the model with this algorithm may yield an optimal transmission power allocation ratio and optimal offloading decisions as practically applicable optimal control parameters. Since the solution process adheres to the constraints of the smart factory model, these optimal parameters will not violate its limitations, therefore, the validities of these optimal parameters can be ensured.

In block 106, an optimal production plan may be determined based on the optimal transmission power allocation ratio and the optimal offloading decisions, and an intelligent production may be performed according to the optimal production plan.

In some examples of the present disclosure, when determining and executing the optimal production plan based on the optimal transmission power allocation ratio and the offloading decisions, reasonable energy allocation may be performed for the tasks with different dependency types (including internal task dependencies and external task dependencies). Furthermore, the optimal transmission power allocation ratio and the offloading decisions may enable a rational allocation of transmission power for both data sharing between tasks and task offloading to the edge. This allows for full utilizations of the MEs' transmission power and effective allocation of transmission power resources. The smart factory model enforces constraints on each device's own energy and the execution time of each task. This guarantees that during intelligent production under the optimal plan, each task has sufficient energy support and can be completed within the stipulated time. This ensures all devices in the entire smart factory can complete one production operation while minimizing the production cost.

In summary, the intelligent production method based on a DAG provided by examples of the present disclosure may achieve a unified management of dependency relationships between tasks by constructing a composite DAG based on internal and external dependencies. This provides a dependency foundation for a rational allocation of transmission power resources between sending data to edge servers and sending data to other MEs. It may determine performance limitations of the MEs themselves by constructing device models. It may simulate an actual production process by building the smart factory model. Solving the smart factory model with a goal of minimizing a cost may yield an optimal transmission power allocation ratio and offloading decisions. Implementing these optimizations may minimize energy and time costs of the smart factory. Crucially, the smart factory model inherently constrains parameters like the transmission power allocation ratio, the devices' own energy consumption, and production time. This ensures the optimal production plan will not exceed the time limits of the tasks nor cause production halts due to insufficient energy. Thus, while minimizing production costs, it may guarantee each ME has sufficient energy support and meets all production time constraints.

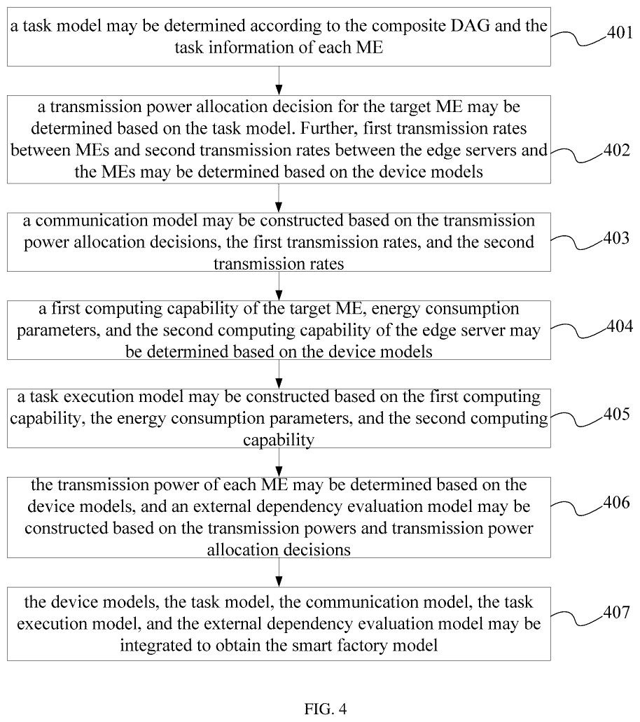

In some examples of the present disclosure, as shown in FIG. 4, the procedure of constructing the smart factory model based on the composite DAG, the device models, and the task information of each ME may include the following steps.

In block 401, a task model may be determined according to the composite DAG and the task information of each ME.

Specifically, in examples of the present disclosure, determining the task model according to the composite DAG and the task information of each ME may include the following steps.

In a first step, predecessor tasks for each task may be determined according to the composite DAG to obtain a predecessor task set of each task.

Specifically, the composite DAG may reveal all tasks within the smart factory and the dependency relationships between them. Consequently, the predecessor tasks for each task can be determined based on the composite DAG. For example, as illustrated in FIG. 2, the predecessor tasks for task q_{2,7} may include tasks q_{2,4}, q_{2,5}, and q_{2,6}. Tasks q_{2,7}, q_{2,4}, q_{2,5}, and q_{2,6} all belong to a same ME, and these relationships can be determined based on the internal dependency relationships within the composite DAG. The predecessor tasks for task q_{1,6} may include tasks q_{2,7}, and q_{1,5}. Here, q_{1,6} and q_{1,5} belong to the same ME (the relationship can be determined based on the internal dependency relationships), while q_{1,6} and q_{2,7} belong to different MEs (the relationship can be determined based on the external dependency relationships).

It is evident that a task within the composite DAG can serve as an input end for multiple external dependency relationships or an output end for multiple external dependency relationships. Therefore, the predecessor task set for task q_{i,j} may be defined as Ψ_{i,j}={q_{l,s}∈q_{i′,j′}, ∪q_{i,k}|ed(q_{i′,j′},q_{i,j})∈EDᵢ,id(q_{i,k},q_{i,j})∈IDᵢ}, representing all predecessor tasks of task q_{i,j}.

In a second step, an offloading decision for each task may be determined in the composite DAG according to the task information.

The task information for task q_{i,j} may include three elements denoted as (x_{i,j}, o_{i,j}, z_{i,j}), where, x_{i,j} represents a task execution computation load, which represents a computational resources required to execute task q_{i,j}. o_{i,j} represents a return data volume when task q_{i,j} is executed on an edge server. If the task is offloaded to an edge server for execution, returning computation result data to the ME is necessary to accomplish the task. z_{i,j} represents the offloading decision of task q_{i,j}. When z_{i,j}=0, task q_{i,j} may be executed locally by MEᵢ itself (the offloading destination is MEᵢ itself). Otherwise, task q_{i,j} may be offloaded to an edge server for execution (the offloading destination may be any edge server). Hence, the offloading decision of task q_{i,j} may be as follows:

$${z}_{i , j} = \{ \begin{matrix}0 , task {q}_{i , j} executed by {ME}_{i} \\ m , task {q}_{i , j} offloaded to {ES}_{m}\end{matrix} .$$

In a third step, offloading destinations for tasks within the combination DAG may be determined based on the offloading decisions.

In a fourth step, the predecessor task sets, the combination DAG, and the offloading destination of each task may be integrated to obtain the task model.

It should be noted that virtual tasks can only be executed by the ME itself. Therefore, the offloading decisions for the start task and the exit task would be both 0, that is, z_{i,0}=z_{i,D}_{ᵢ}₊₁=0, ∀i∈{1,2, . . . , N}, to indicate there is no offloading.

By integrating the predecessor task sets, the combination DAG, and the offloading destination of each task, the relationships between tasks, their execution order, and their offloading destinations may be determined. This establishes all model data related to the tasks, resulting in the task model.

In block 402, a transmission power allocation decision for the target ME may be determined based on the task model. Further, first transmission rates between MEs and second transmission rates between the edge servers and the MEs may be determined based on the device models.

In some examples of the present disclosure, when MEᵢ sends data for task q_{i,j} to ME_{i′}, φ_{i,j} refers to a first allocation ratio of the transmission power

$${p}_{i}^{trans}$$

used for data transmission between MEᵢ and ME_{i′}. Conversely, 1−φ_{i,j} represents a second allocation ratio of transmission power

$${p}_{i}^{trans}$$

used for data transmission between MEᵢ and an edge server. φ_{i,j}=0 indicates that task q_{i,j} has no external dependencies and q_{i,j} may be executed by MEᵢ itself. If task q_{i,j} has external dependencies, a transmission power

$${p}_{i}^{trans}$$

allocation must be performed. Thus, the transmission power allocation decision may be denoted as Θ={φ_{i,j} ∈[0, 1)|i∈{1,2, . . . , N}, j∈{0,1,2, . . . , Dᵢ, Dᵢ+1}}.

Using Orthogonal Frequency Division Multiplexing (OFDM), each ME may communicate with the edge server over orthogonal channels, ensuring no interference between communication links. When task q_{i,j} needs to be offloaded to edge server ESₘ for execution, MEᵢ needs to transmit required data for executing q_{i,j} to ESₘ. According to Shannon's theorem, an achievable uplink transmission rate (the second transmission rate) may be denoted as

$${R}_{i , j}^{m} = {w log}_{2} ( 1 + \frac{( 1 - {φ}_{i , j} ) {p}_{i}^{t r a n s} {h}_{i , m}}{{δ}^{2}} ) .$$

Here, w represents a channel bandwidth between the ME and the edge server; δ² represents a channel noise between the ME and the edge server; and h_{i,m} represents a channel gain between MEᵢ and edge server ESₘ, which may depend on the distance d_{i,m} between them, i.e.,

$${h}_{i , m} = {d}_{i , m}^{- ρ} ,$$

where ρ represents a path loss exponent. Assuming that each wireless channel is symmetric, the achievable downlink transmission rate may be the same as the uplink rate.

Due to the existence of external dependencies, data transmission also occurs between MEs. Different frequency band channels may be used for data transmissions to avoid interferences. When task q_{i′,j′} in G_{i′} requires data from task q_{i,j} in Gᵢ, data of q_{i,j} needs to be transmitted to q_{i′,j′}. The transmission rate in this case may be the second transmission rate:

$${R}_{i , j}^{{i}^{′}} = {w}_{0} {log}_{2} ( 1 + \frac{{φ}_{i , j} {p}_{i}^{t r a n s} {h}_{i , {i}^{′}}}{{δ}^{2}} ) .$$

Here, w₀ represents a channel bandwidth for communication between the MEs; δ² represents a channel noise for communications between the MEs; and h_{i,i′} represents a channel gain for communication between the MEs. h_{i,i′} may depend on the distance d_{i,i′} between them, i.e.,

$${h}_{i , i ′} = {d}_{i , i ′}^{- ρ} ,$$

where ρ represents a path loss exponent.

In block 403, a communication model may be constructed based on the transmission power allocation decisions, the first transmission rates, and the second transmission rates.

In some examples of the present disclosure, the step of constructing the communication model based on the transmission power allocation decisions, the first transmission rates, and the second transmission rates may include the following steps.

In a first step, task dependency relationships between a target task and its target predecessor tasks may be constructed according to the task model.

In some examples of the present disclosure, the target task may be denoted as q_{i,j} and one of its target predecessor tasks may be denoted as q_{l,s}. If a directed edge between the target task and the target predecessor task belongs to the internal dependency set IDᵢ, the task dependency relationship between them may be determined as an internal dependency relationship. If the directed edge between the target task and the target predecessor task belongs to the external dependency set EDⱼ, the task dependency relationship between them may be determined as an external dependency relationship.

In a second step, in response to determining the task dependency relationship is an internal dependency relationship, determine an edge transmission delay based on the first transmission rates and a data volume of the target task, and set the edge transmission delay as the task transmission delay.

In a third step, in response to determining the task dependency relationship is an external dependency relationship, determine an edge transmission delay based on the first transmission rates and a data volume of the target task, determine an external transmission delay based on the second transmission rates and the data volume of the target task, and set a sum of the external transmission delay and the edge transmission delay as the task transmission delay.

In some examples of the present disclosure, because the task dependency relationship between the target task and its target predecessor task may differ, the task transmission delay required for target task q_{i,j} to receive data transmitted from its target predecessor task q_{l,s} to its execution location can be calculated as:

$${T}_{l , s}^{i , j} = \{ \begin{matrix}{1}_{\{ {z}_{i , j} \}} \frac{{id}_{l , s}^{i , j}}{{R}_{i , j}^{m}} , id ( {q}_{l , s} , {q}_{i , j} ) ∈ {ID}_{l} \\ \frac{{ed}_{l , s}^{i , j}}{{R}_{l , s}^{i}} + {1}_{\{ {z}_{i , j} \}} \frac{{ed}_{l , s}^{i , j}}{{R}_{i , j}^{m}} , ed ( {q}_{l , s} , {q}_{i , j} ) ∈ {ED}_{l}\end{matrix} .$$

When the target predecessor task q_{l,s} and the target task q_{i,j} have an internal dependency relationship, i.e., id(q_{l,s},q_{i,j})∈IDₗ, only the edge transmission delay

$${1}_{\{ {z}_{i , j} \}} \frac{{id}_{l , s}^{i , j}}{{R}_{i , j}^{m}}$$

needs to be calculated, considering whether target task q_{i,j} is offloaded to the edge server. When the target predecessor task q_{l,s} and the target task q_{i,j} have an external dependency relationship, i.e., ed(q_{l,s},q_{i,j})∈EDₗ, the external transmission delay

$$\frac{{ed}_{l , s}^{i , j}}{{R}_{l , s}^{i}}$$

between target predecessor task q_{l,s} and the target task q_{i,j} may be considered, along with the edge transmission delay

$${1}_{\{ {z}_{i , j} \}} \frac{{ed}_{l , s}^{i , j}}{{R}_{i , j}^{m}} .$$

Here, 1_{{z}_{_{i,j}}_{}} is an indicator function, if an event is true, the function value is 1; and if the event is false, the function value is 0. For the edge transmission delays

$${1}_{\{ {z}_{i , j} \}} \frac{i {d}_{l , s}^{i , j}}{{R}_{i , j}^{m}} and {1}_{\{ {z}_{i , j} \}} \frac{e {d}_{l , s}^{i , j}}{{R}_{i , j}^{m}} ,$$

if the offloading decision z_{i,j}=0, it means task q_{i,j} is executed by the ME itself and there is no process of offloading task data to the edge server, so the event is false. If the offloading decision z_{i,j}=m, it means task q_{i,j} is executed by the edge device ESₘ, requiring task data to be uploaded to the edge server, so the event is true.

In a fourth step, a task reception delay may be determined based on a return data volume of the target task and the second transmission rates.

In some examples of the present disclosure, when the event is true, after the target task is executed in the edge server ESₘ, an execution result needs to be returned to MEᵢ, then the transmission delay for receiving the execution result may be

$${T}_{i , j}^{r e c e i} = \frac{{o}_{i , j}}{{R}_{i , j}^{m}} .$$

In a fifth step, a communication delay may be determined based on the task reception delay and task transmission delay.

In some examples of the present disclosure, the communication delay may be 0 when the event is false. And when the event is true, the sum of the task reception delay and task transmission delay may be determined as the communication delay. The communication delay represents the delay generated by task data transmission when executing the tasks.

In a sixth step, a transmission energy consumption of the target task may be determined based on the transmission power allocation decisions, the transmission power of the target ME, the reception power of the target ME, and the transmission data volume.

In some examples of the present disclosure, in the process of transmitting the data required by the target task q_{i,j} to its execution location, the transmission energy consumption of the ME can be calculated as

$${E}_{l , s}^{i , j} = {\sum }_{i d ( {q}_{l , s} , {q}_{i , j} ) ∈ {ID}_{l}} {1}_{\{ {z}_{i , j} \}} ( 1 - {φ}_{i , j} ) {p}_{i}^{trans} \frac{i {d}_{l , s}^{i , j}}{{R}_{i , j}^{m}} + {\sum }_{e d ( {q}_{l , s} , {q}_{i , j} ) ∈ {ED}_{l}} {p}_{i}^{r e c e i} \frac{e {d}_{l , s}^{i , j}}{{R}_{l , s}^{i}} + {1}_{\{ {z}_{i , j} \}} ( 1 - {φ}_{i , j} ) {p}_{i}^{trans} \frac{e {d}_{l , s}^{i , j}}{{R}_{i , j}^{m}} .$$

Where

$${\sum }_{i d ( {q}_{l , s} , {q}_{i j} ) ∈ {ID}_{l}} {1}_{\{ {z}_{i , j} \}} ( 1 - {φ}_{i , j} ) {p}_{i}^{trans} \frac{i {d}_{l , s}^{i , j}}{{R}_{i , j}^{m}}$$

represents the transmission energy consumption of transmitting the target task q_{i,j} to the edge server when there is no external dependency relationship.

$${\sum }_{e d ( {q}_{l , s} , {q}_{i , j} ) ∈ {ID}_{l}} {p}_{i}^{r e c e i} \frac{e {d}_{l , s}^{i , j}}{{R}_{l , s}^{i}} + {1}_{\{ {z}_{i , j} \}} ( 1 - {φ}_{i , j} ) {p}_{i}^{trans} \frac{e {d}_{l , s}^{i , j}}{{R}_{i , j}^{m}}$$

represents the energy consumption of external dependency transmission and the energy consumption of transmitting the task to the edge server when external dependencies exist.

In a seventh step, a reception energy consumption may be determined based on the return data volume, the second transmission rate, and the reception power of the target ME.

In some examples of the present disclosure, after the target task q_{i,j} is executed in the edge server ESₘ, the execution result needs to be returned to MEᵢ, then the reception energy consumption for receiving the execution result may be denoted as

$${E}_{i , j}^{r e c e i} = \frac{{o}_{i , j}}{{R}_{i , j}^{m}} {p}_{i}^{r e c e i} .$$

In an eighth step, a communication energy consumption may be determined based on the reception energy consumption and transmission energy consumption.

In some examples of the present disclosure, according to different offloading decisions, the event may be true or false. When the event is false, only the transmission energy consumption needs to be considered, and the transmission energy consumption may be determined as the communication energy consumption. When the event is true, the sum of the reception energy consumption and transmission energy consumption may be determined as the communication energy consumption.

In a ninth step, the communication delay and communication energy consumption may be integrated to obtain the communication model.

In some examples of the present disclosure, the communication model may include the communication delay and communication energy consumption for data transmission between the MEs and between the MEs and the edge servers. The communication model can be obtained by integrating the communication delay and communication energy consumption.

In block 404, a first computing capability of the target ME, energy consumption parameters, and the second computing capability of the edge server may be determined based on the device models.

In some examples of the present disclosure, the first computing capability of the target ME may be denoted as fᵢ, the second computing capability of the edge server may be denoted as fₘ, and the energy consumption parameters of the target ME may include a working power

$${p}_{i}^{ME} ,$$

a transmission power

$${p}_{i}^{trans} ,$$

a reception power

$${p}_{i}^{r e c e i} ,$$

a standby power

$${p}_{i}^{wait} ,$$

and an available energy

$${E}_{i}^{ME} .$$

In block 405, a task execution model may be constructed based on the first computing capability, the energy consumption parameters, and the second computing capability.

In some examples of the present disclosure, the energy consumption parameters may include a working power and a standby power. The step of constructing the task execution model based on the first computing capability, energy consumption parameters, and second computing capability may include the following steps.

In a first step, a task completion time of the target predecessor task of the target task may be determined based on the task model. Further, a task transmission delay between the target task and the target predecessor task may be determined based on the communication model. Moreover, a sum of the task completion time and task transmission delay may be determined as the task start time.

In some examples of the present disclosure, due to the existence of internal and external dependency relationships between tasks, the complexity of execution delay analysis may be increased. For convenience,

$${T}_{i , j}^{ST}$$

may be used to represent a task start time for executing the target task q_{i,j},

$${T}_{i , j}^{RT}$$

may be used to represent a running time for executing the target task q_{i,j}, and

$${T}_{i , j}^{CT}$$

may be used to represent the task completion time for executing the target task q_{i,j}.

The task start time of the target task q_{i,j} may be denoted as

$${T}_{l , s}^{CT} + {T}_{l , s}^{i , j} ,$$

that is, the sum of the task completion time

$${T}_{l , s}^{CT}$$

of its target predecessor task q_{l,s} and the task transmission delay

$${T}_{l , s}^{i , j}$$

for transmitting the data of the target predecessor task q_{l,s} to the execution location of task q_{i,j}.

In a second step, a maximum task start time may be determined among the task start times corresponding to different predecessor tasks as the task start time of the target task.

In some examples of the present disclosure, the task start time of the target task q_{i,j} is the maximum value of the sum of the task completion time

$${T}_{l , s}^{ST}$$

of its target predecessor task q_{l,s} and the task transmission delay

$${T}_{l , s}^{i , j}$$

for transmitting the data of the target predecessor task q_{l,s} to the execution location of the target task q_{i,j}, because only when the last predecessor task transmission is completed can it be ensured that all data required for target task execution has been obtained. Therefore, the maximum task start time among the task start times corresponding to different predecessor tasks may be determined as the task start time of the target task, then the task start time may be expressed as

$${T}_{i , j}^{ST} = {max}_{{q}_{l , s} ∈ {Ψ}_{i , j}} \{ {T}_{l , s}^{CT} + {T}_{l , s}^{i , j} \}$$

In a third step, a target offloading destination of the target task may be determined based on the task model.

In some examples of the present disclosure, when the offloading decision of the task model is z_{i,j}=0, the target task q_{i,j} may be executed by MEᵢ, then the target offloading destination is the target ME corresponding to the target task. When the offloading decision of the task model is z_{i,j}=m, the target task q_{i,j} may be offloaded to the edge server ESₘ for execution, then the target offloading destination is the edge server.

In a fourth step, in response to determining the target offloading destination is the target ME corresponding to the target task, determine the internal execution delay based on the task execution computation load of the target task and the first computing capability, determine the product of the internal execution delay and working power as the internal computing energy consumption, determine the internal computing delay as the task execution delay, and determine the internal computing energy consumption as the task execution energy consumption.

In a fifth step, in response to determining the target offloading destination is the edge server, determine the external execution delay based on the task execution computation load of the target task and the second computing capability, determine the product of the external execution delay and standby power as the internal standby energy consumption, determine the sum of the external computing delay and task reception delay as the task execution delay, and determine the sum of the internal standby energy consumption and reception energy consumption as the task execution energy consumption.

In some examples of the present disclosure, when the target task q_{i,j} is executed by the target ME itself, i.e., z_{i,j}=0, the internal execution delay may be determined based on the task execution computation load of the target task and the first computing capability, which can be expressed as

$${T}_{i , j}^{ME} = \frac{{x}_{i , j}}{{f}_{i}} .$$

Similarly, when the target task q_{i,j} is offloaded to the edge server ESₘ for execution, i.e., z_{i,j}=m, the external execution delay may be determined based on the task execution computation load of the target task and the second computing capability, which can be expressed as

$${T}_{i , j}^{{ES}_{m}} = \frac{{x}_{i , j}}{{f}_{i}} .$$

When the target task q_{i,j} is executed by the target ME itself, i.e., z_{i,j}=0, only the energy consumption of the ME is considered. That is, the product of the internal execution delay and working power may be determined as the internal computing energy consumption, which can be expressed as

$${E}_{i , j}^{ME} = {T}_{i , j}^{ME} {p}_{i}^{ME} .$$

Although the computing energy consumption of the edge server is not considered when the target task is offloaded to the edge server, during the process of executing the target task in the edge server, the target ME is in standby mode, ready to receive the computation results from the edge server at any time. Therefore, the standby energy consumption of the target ME also needs to be considered, then the product of the external execution delay and standby power is determined as the internal standby energy consumption, which can be expressed as

$${E}_{i , j}^{wait} = {T}_{i , j}^{{ES}_{m}} {p}_{i}^{wait} .$$

Therefore, when the target offloading destination is the target ME corresponding to the target task, the internal computing delay may be determined as the task execution delay, and the internal computing energy consumption may be determined as the task execution energy consumption. When the target offloading destination is the edge server, the external computing delay may be determined as the task execution delay, and the internal standby energy consumption and data reception energy consumption may be determined as the task execution energy consumption.

In these cases, the task execution delay (also called as running time) may be expressed as

$${T}_{i , j}^{RT} = {1}_{\{ ! {z}_{i , j} \}} {T}_{i , j}^{ME} + {1}_{\{ {z}_{i , j} \}} ( {T}_{i , j}^{{ES}_{m}} + {T}_{i , j}^{recei} ) .$$

The task execution energy consumption (also called as running energy consumption) may be expressed as

$${E}_{i , j}^{r u n} = {1}_{\{ ! {z}_{i , j} \}} {E}_{i , j}^{M E} + {1}_{\{ {z}_{i , j} \}} ( {E}_{i , j}^{wait} + {E}_{i , j}^{r e c e i} ) .$$

In a sixth step, a target task completion time of the target task may be determined based on the task start time and task execution delay.

In some examples of the present disclosure, the target task completion time of the target task may be determined by

$${T}_{i , j}^{C T} = {T}_{i , j}^{S T} + {T}_{i , j}^{R T} .$$

In a seventh step, in response to determining the target task is a final task, the target task completion time may be determined as a production completion time of the target ME, and determine the maximum value among the production completion times corresponding to different ME as the total production time.

In some examples of the present disclosure, when the target task is the last task of the target ME, i.e., j=Dᵢ, the target task completion time

$${T}_{i , j}^{C T}$$

may equal to the production completion time

$${T}_{i , {D}_{i}}^{C T}$$

of the target ME. Since the total production time of one production operation of the ME may be the production completion time of the last task in the single DAG corresponding to the ME, then it means

$${T}_{M {E}_{i}}^{C T} = {T}_{i , {D}_{i}}^{C T} .$$

For the entire smart factory, only when the last ME completes production can it be determined that a complete production operation has been completed. Then the total production time for all ME in the smart factory to perform one production operation is the maximum value among the production completion times corresponding to different ME, and a total production time may be expressed as

$$T = {max}_{i} {T}_{M {E}_{i}}^{C T} .$$

In an eighth step, a single device energy consumption of the target ME may be determined based on the task execution energy consumption and transmission energy consumption, and a sum of the single device energy consumption of all ME may be determined as a total energy consumption.

In some examples of the present disclosure, the single device energy consumption consumed by MEᵢ for one production operation may be expressed as

$${E}_{i} = {\sum }_{j = 1}^{{D}_{i}} ( {E}_{i , j}^{r u n} + {E}_{l , s}^{i , j} ) .$$

Then the total energy consumption for the smart factory to execute one production operation may be the sum of the single device energy consumption of all ME, and the total energy consumption may be expressed as

$$E = {\sum }_{i = 1}^{N} {E}_{i} .$$

In a ninth step, the total energy consumption and the total production time may be integrated to obtain the task execution model.

In some examples of the present disclosure, the task execution model may include the production completion time and single device energy consumption of an individual device, as well as the total energy consumption and total production time of the entire smart factory. The production completion time may be a component of the total production time, and the single device energy consumption may be a component of the total energy consumption. Therefore, the task execution model can be obtained by integrating the total energy consumption and the total production time.

In block 406, the transmission power of each ME may be determined based on the device models, and an external dependency evaluation model may be constructed based on the transmission powers and transmission power allocation decisions.

In some examples of the present disclosure, the external dependency relationships between MEs can improve production efficiency and save some production costs. However, due to the limited resources of an ME, its own available energy and transmission power will be consumed in the process of external dependency data sharing. Therefore, it is necessary to reasonably evaluate the energy consumption of the ME and the allocation of transmission power. In this case, an external dependency evaluation model may be proposed for evaluation, which can be expressed as

$$E v {a}_{i , j} = {\sum }_{ed ( {q}_{i , j} , {q}_{i ′ , j ′} ) ∈ E {D}_{i}} {φ}_{i , j} {p}_{i}^{trans} {log}_{10}^{{ed}_{i , j}^{{i}^{′} , j ′}} .$$

As the amount of shared data in external dependencies increases, the advantages of data sharing gradually weaken and even become negligible. Therefore,

$${log}_{10}^{e {d}_{i , j}^{{i}^{′} , j ′}}$$

may be used to evaluate the impact of shared data volume, and the total external dependency evaluation may be expressed as

$$Eva = {\sum }_{i = 1}^{N} {\sum }_{j = 0}^{{D}_{i} + 1} {Eva}_{i , j} .$$

In block 407, the device models, the task model, the communication model, the task execution model, and the external dependency evaluation model may be integrated to obtain the smart factory model.

In some examples of the present disclosure, by integrating the device models, the task model, the communication model, the task execution model, and the external dependency evaluation model, all functions of the smart factory can be completely executed, achieving a simulation of the smart factory and obtaining the smart factory model.

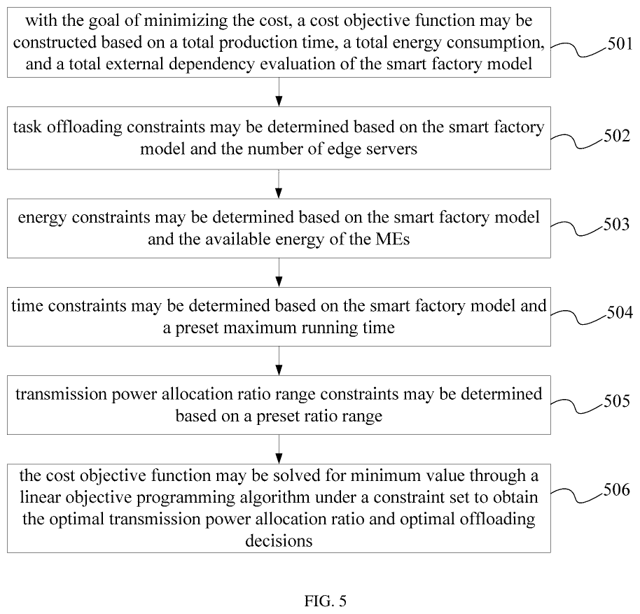

In some examples of the present disclosure, as shown in FIG. 5, with a goal of minimizing a cost, the smart factory model may be solved through a linear objective programming algorithm to obtain an optimal transmission power allocation ratio and optimal offloading decisions by a method which includes the following steps.

In block 501, with the goal of minimizing the cost, a cost objective function may be constructed based on a total production time, a total energy consumption, and a total external dependency evaluation of the smart factory model.

In some examples of the present disclosure, the cost objective function with the goal of minimizing the cost can be expressed as

$$P : {min}_{Θ , Z} α E + β T - γ Eva .$$

Where E represents the total energy consumption, T represents the total production time, Eva represents the total external dependency evaluation, and α, β, γ are weight parameters. Θ and Z are variables of the optimization problem. Θ represents the transmission power allocation ratio, and Z represents the offloading decision.

In block 502, task offloading constraints may be determined based on the smart factory model and the number of edge servers.

In block 503, energy constraints may be determined based on the smart factory model and the available energy of the MEs.

In block 504, time constraints may be determined based on the smart factory model and a preset maximum running time.

In block 505, transmission power allocation ratio range constraints may be determined based on a preset ratio range.

In block 506, the cost objective function may be solved for minimum value through a linear objective programming algorithm under a constraint set to obtain the optimal transmission power allocation ratio and optimal offloading decisions. Where, the constraint set may include task offloading constraints, energy constraints, time constraints, and preset transmission power allocation ratio range constraints.

In some examples of the present disclosure, the constraint set can be expressed as:

$$\begin{matrix}s . t . C 1 : {φ}_{i , j} ∈ ( 0 , 1 ) , ∀ i ∈ \{ 1 , 2 , … , N \} , j ∈ \{ 0 , 1 , 2 , … , {D}_{i} , {D}_{i} + 1 \} \\ C 2 : {z}_{i , j} ∈ \{ 1 , 2 , … , M \} , ∀ i ∈ \{ 1 , 2 , … , N \} , j ∈ \{ 0 , 1 , 2 , … , {D}_{i} \} \\ C 3 : {z}_{i , 0} = {z}_{i , {D}_{i} + 1} = 0 , ∀ i ∈ \{ 1 , 2 , … , N \} \\ C 4 : {E}_{i}^{M E} - {E}_{i} - {{\sum }^{{D}_{i} + 1}}_{j = 0} {\sum }_{ed ( {q}_{i , j} , {q}_{{i}^{′} , {j}^{′}} ) ∈ {ED}_{i}} {φ}_{i , j} {p}_{i}^{trans} \frac{e {d}_{i , j}^{{i}^{′} , {j}^{′}}}{{R}_{i , j}^{{i}^{′}}} \geq 0 \\ C 5 : {T}_{i , j}^{R T} \leq {T}_{max}^{R T}\end{matrix}$$

The transmission power allocation ratio range constraints C1 may represent a range of transmission power allocation ratios for data sharing in external dependencies. Only when the allocation ratio is within the preset ratio range (0,1) does it indicate that transmission power allocation has been performed. The task offloading constraints may include offloading range constraints C2 and virtual task offloading constraints C3. The smart factory model limits the choice of task offloading destinations, i.e., it can only be the ME itself or the edge servers, and the number of the edge servers constrains the selection range of edge servers, resulting in the offloading range constraint C2. In the smart factory model, entry tasks and exit tasks can only be executed on the ME itself, resulting in virtual task offloading constraint C3. The energy constraints C4 determined based on the smart factory model and the available energy of ME may be the self-energy constraints of each ME, ensuring that the available energy provides data sharing energy

$${\sum }_{j = 0}^{{D}_{i} + 1} {\sum }_{e d ( {q}_{i , j} , {q}_{{i}^{′} , {j}^{′}} ) ∈ E {D}_{i}} {φ}_{i , j} {p}_{i}^{trans} \frac{e {d}_{i , j}^{{i}^{′} , {j}^{′}}}{{R}_{i , j}^{{i}^{′}}}$$

for the allocated transmission power while satisfying the single device energy consumption for its own task execution. The time constraints C5 may limit that the total production time of the smart factory cannot exceed the maximum running time

$${T}_{max}^{R T} .$$

Under the constraints of the constraint set, the cost objective function can be solved for minimum value through the linear objective programming algorithm to obtain the optimal transmission power allocation ratio and optimal offloading decisions. That is, when the calculation result of the cost objective function is minimum, Θ is the optimal transmission power allocation ratio, and when the calculation result of the cost objective function is minimum, Z represents the optimal offloading decisions. The optimal transmission power allocation ratio changes the transmission power input, and the optimal offloading decision determines whether each ME executes tasks itself or offloads tasks to edge servers. When offloading to edge servers, it comprehensively considers energy consumption and delay to select the most suitable edge server while ensuring low energy consumption and low delay. The optimal transmission power allocation ratio can achieve the most efficient use of available energy to avoid energy shortage situations.

By constructing a smart factory model to simulate the actual production process and solving the smart factory model with the goal of minimum cost, the optimal transmission power allocation ratio and optimal offloading decision are obtained. Through the optimal transmission power allocation ratio and optimal offloading decision, the energy cost and time cost of the smart factory can be minimized. The smart factory model itself limits parameters such as transmission power allocation ratio, ME's own energy consumption, and production time, ensuring that the optimal production plan will not exceed the time limit of tasks and will not cause production stagnation due to energy shortage, minimizing production costs while ensuring that each ME has sufficient energy support and meets production time limits.

It should be noted that the method of examples of the present disclosure can be executed by a single device, such as a computer or server. The method of examples of the present disclosure can also be applied to distributed scenarios, completed by multiple devices cooperating with each other. In the case of such distributed scenarios, one of these multiple devices may only execute one or more steps in the method of examples of the present disclosure, and these multiple devices will interact with each other to complete the described method.

It should be noted that the above describes some examples of the present disclosure. Other examples are within the scope of the appended claims. In some cases, the actions or steps recorded in the claims can be executed in a different order than in the above examples and still achieve the desired results. In addition, the processes depicted in the drawings do not necessarily require the specific order or sequential order shown to achieve the desired results. In certain implementations, multitasking and parallel processing are also possible or may be advantageous.

In summary, examples of the present disclosure propose a model for determining the optimal transmission power allocation ratio, first performing reasonable power allocation for task pairs with different dependency relationships (internal dependencies, external dependencies); then performing reasonable allocation of transmission power for both cases of data sharing between tasks and task offloading to edge. This can fully utilize the transmission power of ME and effectively allocate transmission power resources.

Moreover, examples of the present disclosure set the ME's own available energy and maximum running time, ensuring that each task has sufficient energy support, and can ensure that all devices in the entire smart factory can complete one production operation within the specified time while minimizing production costs.

Based on the same inventive concept, corresponding to any of the above method, examples of the present disclosure may also provide an ME based on a DAG.

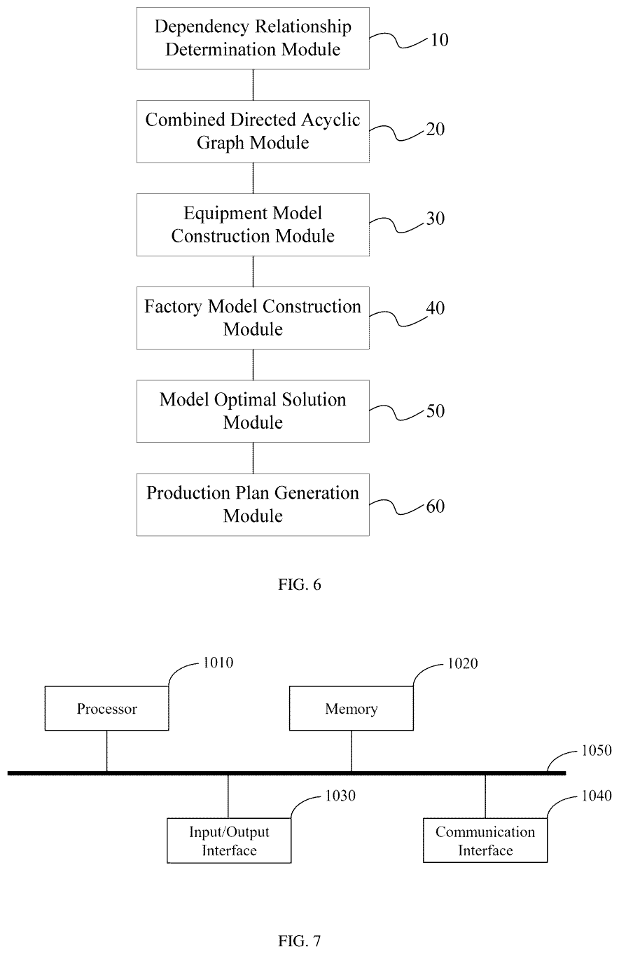

Referring to FIG. 6, the ME based on the DAG may include the following components.

A dependency relationship determination module 10, configured to determine external dependency relationships between different MEs and internal dependency relationships within a same ME.

A composite DAG module 20, configured to construct a composite DAG based on the external dependency relationships and the internal dependency relationships.

A device model construction module 30, configured to construct a device model based on performance parameters of each ME and each edge server.

A factory model construction module 40, configured to construct a smart factory model based on the composite DAG, the device model, and task information of each ME.

A model optimal solution module 50, configured to solving the smart factory model using a linear goal programming algorithm with an objective of minimizing a total cost, to obtain an optimal transmission power allocation ratio and an optimal offloading decision.

A production plan generation module 60, configured to determine an optimal production plan based on the optimal transmission power allocation ratio and the optimal offloading decision; and execute an intelligent production according to the optimal production plan.

For convenience of description, when describing the above device, the functions are divided into various modules for separate description. Of course, when implementing this application, the functions of each module can be implemented in the same or multiple software and/or hardware.

The device may be used to implement the corresponding intelligent production method based on a DAG in any of the preceding examples, and has the beneficial effects of the corresponding method, which will not be repeated here.

Based on the same inventive concept, corresponding to any of the above method, this application also provides an electronic device, including a memory, a processor, and a computer program stored on the memory and runnable on the processor, where the processor implements the intelligent production method based on the DAG described in any of the above examples when executing the program.

FIG. 7 shows a schematic diagram of a more specific hardware structure of an electronic device provided by examples of the present disclosure. The device may include: a processor 1010, a memory 1020, an input/output interface 1030, a communication interface 1040, and a bus 1050. Where the processor 1010, the memory 1020, the input/output interface 1030, and the communication interface 1040 achieve internal communication connections within the device through the bus 1050.

The processor 1010 can be implemented using a general-purpose CPU (Central Processing Unit), microprocessor, application specific integrated circuit (ASIC), or one or more integrated circuits, for executing related programs to implement the technical solutions provided by examples of this specification.

The memory 1020 can be implemented in the form of ROM (Read Only Memory), RAM (Random Access Memory), static storage devices, dynamic storage devices, etc. The memory 1020 can store operating systems and other applications. When implementing the technical solutions provided by examples of the present disclosure through software or firmware, the relevant program code is stored in the memory 1020 and called and executed by the processor 1010.

The input/output interface 1030 is used to connect input/output modules to achieve information input and output. The input/output module can be configured as a component in the device (not shown in the figure), or can be external to the device to provide corresponding functions. Input devices may include keyboards, mice, touch screens, microphones, various sensors, etc., and output devices may include displays, speakers, vibrators, indicator lights, etc.

The communication interface 1040 is used to connect communication modules (not shown in the figure) to achieve communication interaction between this device and other devices. The communication module can achieve communication through wired means (such as USB, network cable, etc.) or wireless means (such as mobile networks, WIFI, Bluetooth, etc.).

The bus 1050 includes a pathway that transmits information between various components of the device (such as the processor 1010, the memory 1020, the input/output interface 1030, and the communication interface 1040).

It should be noted that although the above device only shows the processor 1010, the memory 1020, the input/output interface 1030, the communication interface 1040, and the bus 1050, in the some examples of the present disclosure, the device may also include other components necessary for normal operation. In addition, those skilled in the art can understand that the above device may also only include components necessary to implement the solutions of examples of the present disclosure, and does not necessarily include all components shown in the figure.

The electronic device of the above examples is used to implement the corresponding intelligent production method based on a DAG in any of the preceding examples, and has the beneficial effects of the corresponding methods, which will not be repeated here.

Based on the same inventive concept, corresponding to any of the above methods, this application also provides a non-transitory computer-readable storage medium that stores computer instructions for causing the computer to execute the intelligent production method based on a DAG described in any of the above examples.

The computer-readable media may include permanent and non-permanent, removable and non-removable media that can achieve information storage by any method or technology. Information can be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only optical disc read-only memory (CD-ROM), digital versatile disc (DVD) or other optical storage, magnetic cassette tape, magnetic tape disk storage or other magnetic storage devices or any other non-transmission medium that can be used to store information that can be accessed by computing devices.

The computer instructions stored in the storage medium of the above examples are used to cause the computer to execute the intelligent production method based on the DAG described in any of the above examples, and have the beneficial effects of the corresponding methods, which will not be repeated here.

Based on the same concept, corresponding to any of the above methods, this application also provides a computer program product, including computer program instructions, which when run on a computer, cause the computer to execute the method described in any of the above examples, and have the beneficial effects of the corresponding methods, which will not be repeated here.

It can be understood that before using the technical solutions of various examples in this disclosure, users are informed of the types, scope of use, and usage scenarios of personal information involved through appropriate means, and user authorization is obtained.

For example, in response to receiving an active request from the user, prompt information is sent to the user to clearly prompt the user that the operation they request to perform will require obtaining and using the user's personal information. Thus, users can autonomously choose whether to provide personal information to software or hardware such as electronic devices, applications, servers, or storage media that execute the technical solutions of this disclosure.

As an optional but non-limiting implementation, in response to receiving an active request from the user, the method of sending prompt information to the user can be, for example, a pop-up window, where the prompt information can be presented in text form in the pop-up window. In addition, the pop-up window can also carry selection controls for users to choose “agree” or “disagree” to provide personal information to electronic devices.

It can be understood that the above notification and user authorization process is only illustrative and does not limit the implementation of this disclosure. Other methods that meet relevant laws and regulations can also be applied to the implementation of this disclosure.

Those of ordinary skill in the art should understand that the discussion of any of the above examples is merely exemplary and is not intended to imply that the scope of this application is limited to these examples; under the ideas of this application, the technical features in the above examples or different examples can also be combined, the steps can be implemented in any order, and there are many other variations of different aspects of the examples of the present disclosure as described above, which are not provided in detail for brevity.

In addition, to simplify the description and discussion, and to avoid making the examples of the present disclosure difficult to understand, well-known power/ground connections to integrated circuit (IC) chips and other components may or may not be shown in the provided drawings. Furthermore, devices may be shown in block diagram form to avoid making examples of the present disclosure difficult to understand, and this also takes into account the fact that details regarding the implementation of these block diagram devices are highly dependent on the platform on which examples of the present disclosure will be implemented (i.e., these details should be fully within the understanding of those skilled in the art). Where specific details (e.g., circuits) have been set forth to describe exemplary examples of the present disclosure, it will be apparent to those skilled in the art that examples of the present disclosure can be implemented without these specific details or with variations of these specific details. Therefore, these descriptions should be considered illustrative rather than limiting.

Although this application has been described in conjunction with specific examples of the present disclosure, many alternatives, modifications, and variations of these examples will be apparent to those of ordinary skill in the art based on the foregoing description. For example, other memory architectures (e.g., dynamic RAM (DRAM)) may use the discussed examples.

Examples of the present disclosure are intended to cover all such alternatives, modifications, and variations that fall within the broad scope of the claims of this application. Therefore, any omissions, modifications, equivalent substitutions, improvements, etc., made within the spirit and principles of examples of the present disclosure should be included within the protection scope of this application.

What is claimed is:

1. An intelligent production method based on a directed acyclic graph, comprising:
determining external dependency relationships between different manufacturing equipment, and internal dependency relationships within a same manufacturing equipment;
constructing a composite directed acyclic graph based on the external dependency relationships and the internal dependency relationships; wherein, each manufacturing equipment needs to execute at least one task; constructing the composite directed acyclic graph based on the external dependency relationships and the internal dependency relationships comprises:
determining an internal task set and an internal dependency set according to the internal dependency relationships;
defining a start task and an exit task in the internal task set as virtual tasks;
defining intermediate tasks in the internal task set as real tasks;
determining an external dependency set according to the external dependency relationships; and
constructing the composite directed acyclic graph based on the internal dependency set, the external dependency set and the internal task set;
constructing device models based on performance parameters of each manufacturing equipment and each edge server;
constructing a smart factory model based on the composite directed acyclic graph, the device models, and task information of each manufacturing equipment;
solving the smart factory model using a linear goal programming algorithm with an objective of minimizing a total cost, to obtain an optimal transmission power allocation ratio and an optimal offloading decision; and
determining an optimal production plan based on the optimal transmission power allocation ratio and the optimal offloading decision; and executing an intelligent production according to the optimal production plan.

2. The method according to claim 1, wherein, constructing a smart factory model based on the composite directed acyclic graph, the device models, and task information of each manufacturing equipment comprises:
determining a task model based on the composite directed acyclic graph and the task information of each manufacturing equipment;
determining a transmission power allocation decision for a target manufacturing equipment based on the task model; determining first transmission rates between the manufacturing equipment and second transmission rates between the edge servers and the manufacturing equipment based on the device model;
constructing a communication model based on the transmission power allocation decision, the first transmission rates, and the second transmission rates;
determining a first computing capability and energy consumption parameters of the target manufacturing equipment, and a second computing capability of the edge servers based on the device models;
constructing a task execution model based on the first computing capability, the energy consumption parameters, and the second computing capability;
determining transmission powers of the manufacturing equipment based on the device models;
constructing an external dependency evaluation model based on the transmission powers and the transmission power allocation decision; and
integrating the device models, the task model, the communication model, the task execution model, and the external dependency evaluation model to obtain the smart factory model.

3. The method according to claim 2, wherein, determining the task model based on the composite directed acyclic graph and the task information of each manufacturing equipment comprises:
determining predecessor tasks for each task from the composite directed acyclic graph to obtain a predecessor task set;
determining an offloading decision for each task in the composite directed acyclic graph based on the task information; and
determining an offloading destination for each task in the composite directed acyclic graph from the edge server or the manufacturing equipment corresponding to the task based on the offloading decision; and integrating the predecessor task set, the composite directed acyclic graph, and the offloading destination of each task to obtain the task model.

4. The method according to claim 2, wherein, constructing a communication model based on the transmission power allocation decision, the first transmission rates, and the second transmission rates comprises:
determining a task dependency relationship between a target task and its predecessor tasks based on the task model;
in response to determining the task dependency relationship being an internal dependency relationship, determining an edge transmission delay based on the first transmission rates and a transmission data volume of the target task, and designating the edge transmission delay as a task transmission delay;
in response to determining the task dependency relationship being an external dependency relationship, determining the edge transmission delay based on the first transmission rates and the transmission data volume of the target task, determining an external transmission delay based on the second transmission rates and the transmission data volume of the target task, and designating a sum of the external transmission delay and the edge transmission delay as the task transmission delay;
determining a task reception delay based on a return data volume of the target task and the second transmission rates;
determining a communication delay based on the task reception delay and the task transmission delay;
determining a transmission energy consumption of the target task based on the transmission power allocation decision, the transmission power of the target manufacturing equipment, a reception power of the target manufacturing equipment, and the transmission data volume;
determining a reception energy consumption based on the return data volume, the second transmission rates, and the reception power of the target manufacturing equipment;
determining a communication energy consumption based on the reception energy consumption and the transmission energy consumption; and
integrating the communication delay and the communication energy consumption to obtain the communication model.

5. The method according to claim 2, wherein, the energy consumption parameters comprise an operating power and a standby power; constructing a task execution model based on the first computing capability, the energy consumption parameters, and the second computing capability comprises:
determining a task completion time of a predecessor task of a target task based on the task model; determining a task transmission delay between the target task and the predecessor task based on the communication model; designating a sum of the task completion time and the task transmission delay as a task start time;
designating a maximum task start time corresponding to different predecessor tasks as a task start time of the target task;
determining an offloading destination of the target task based on the task model;
in response to determining the target offloading destination being the target manufacturing equipment corresponding to the target task, determining an internal execution delay based on a task computation load of the target task and the first computing capability, designating a product of the internal execution delay and the operating power as an internal computation energy consumption, designating an internal computation delay as a task execution delay, and designating the internal computation energy consumption as a task execution energy consumption;
in response to determining the target offloading destination being an edge server, determining an external execution delay based on the task computation load of the target task and the second computing capability, designating a product of the external execution delay and the standby power as an internal idle energy consumption, designating a sum of the external computation delay and a task reception delay as the task execution delay, and designating a sum of the internal idle energy consumption and a reception energy consumption as the task execution energy consumption;
determining a target task completion time of the target task based on the task start time and the task execution delay;
in response to determining the target task being a final task, designating the target task completion time as a production completion time of the target manufacturing equipment, and designating a maximum value among the production completion times corresponding to different manufacturing equipment as a total production time;
determining a single-device energy consumption of the target manufacturing equipment based on the task execution energy consumption and a transmission energy consumption, and designating a sum of the single-device energy consumption of all manufacturing equipment as a total energy consumption; and
integrating the total energy consumption and the total production time to obtain the task execution model.

6. The method according to claim 1, wherein, solving the smart factory model using a linear goal programming algorithm with an objective of minimizing a total cost, to obtain an optimal transmission power allocation ratio and an optimal offloading decision comprises:
constructing a cost objective function for minimizing the total cost based on the total production time, a total energy consumption, and a total external dependency evaluation of the smart factory model;
determining task offloading constraints based on the smart factory model and the number of edge servers;
determining energy constraints based on the smart factory model and available energy of manufacturing equipment;
determining time constraints based on the smart factory model and a preset maximum operation time;
determining a transmission power allocation ratio range constraint based on a preset ratio range; and
solving the cost objective function for minimization under a constraint set using the linear goal programming algorithm to obtain the optimal transmission power allocation ratio and the optimal offloading decisions; wherein the constraint set comprises the task offloading constraints, the energy constraints, the time constraints, and the preset transmission power allocation ratio range constraint.

7. An electronic device, comprising:
a memory, a processor, and a computer program stored on the memory and executable on the processor, wherein the processor, when executing the computer program, implements the method according to claim 1.

8. A non-transitory computer-readable storage medium, storing computer instructions, wherein the computer instructions are used to cause a computer to execute the method according to claim 1.
